(19) United States
(12) Patent Application Publication
(10) Pub. No.: US 2001/0027045 A1
(43) Pub. Date: Oct. 4, 2001

(54) Electrical connector system

(76) Inventors: Masahiro Enomoto, Tokyo (JP); Masahiro Sakano, Ebina-shi (JP)

Correspondence Address: Stacey E. Caldwell, MOLEX INCORPORATED, 2222 Wellington Court, Lisle, IL, 60532, US

(21) Appl. No.: 09/759,713

(22) Filed: Jan. 12, 2001

(30) Foreign Application Priority Data
Jan. 21, 2000 (JP) 2000/17779

(51) Int. Cl. H01R 13/64

(52) U.S. Cl. 439/246

(57) ABSTRACT

An electrical connector is mountable on a substrate and receives a terminal pin of a complementary electrical device. The connector includes a dielectric housing adapted for mounting on an upper surface of the substrate and includes a receptacle extending into an appropriate hole in the substrate. A terminal is mounted on the housing and includes a contact portion in registry with the receptacle in the housing. The terminal pin of the electrical device is engaged with the contact portion of the terminal as the pin is inserted into the receptacle of the housing beyond the upper surface of the substrate.

### FIELD OF THE INVENTION

This invention generally relates to the art of electrical connectors and, particularly, to an electrical connector or system for mounting on a substrate such as a printed circuit board and for receiving one or more terminal pins of a complementary electrical device.

### BACKGROUND OF THE INVENTION

FIG. 10 shows somewhat schematically an electrical connector system which is typical of the prior art. In particular, an electrical device 100 includes a plurality of terminal pins or leads 102 projecting from the bottom thereof. The electrical device may be an automotive or vehicular speedometer, for instance. A plurality of socket-terminals 104 are mounted on top of a circuit substrate or printed circuit board 106 and are electrically terminated to appropriate circuit traces (not shown) on the circuit board. Electrical device 100 is connected in the direction of arrow “A” by inserting terminal pins or leads 102 into receptacles 104a of socket terminals 104.

Such electrical connector systems of the prior art as described above in relation to FIG. 1, cause various problems or have various disadvantages. For instance, the entire system has a rather high profile, because socket terminals 104 are mounted on top of circuit board 106 and must accommodate the entire height or length of leads 102 of electrical device 100. In addition, although socket terminals 104 are shown somewhat schematically in FIG. 10, an individual socket terminal is mounted on the circuit board for each lead 102. This is expensive, and the assembly process of the plural components is not cost effective. Still further, since socket terminals 104 are mounted independently on circuit board 106, the terminals are mounted fairly rigid to ensure proper connections with the circuit traces on the circuit board. This allows for little or no flexibility in aligning leads 102 with receptacles 104a. Any misalignment will cause mating problems. Lastly, since terminals 104 are exposed, there is a tendency for leads 102 to be short circuited, causing damage to electrical device 100 which may be a relatively expensive component.

The present invention is directed to solving the myriad of problems enumerated above with such prior art systems as described.

Japanese Patent Application Laid-Open No. HEI 8-5667 discloses an approach for reducing the high profile of such systems. Japanese Patent Application Laid-Open No. HEI 7-146310 discloses an approach for accommodating misalignments in such systems. However, both of these approaches are directed to improving the electrical device 100, per se. On the other hand, the present invention is directed to improving the electrical connections on the circuit board so that the system can be used with existing electrical devices 100.

### SUMMARY OF THE INVENTION

An object, therefore, of the invention is to provide a new and improved electrical connector or system for mounting on a substrate, such as a circuit board, and for receiving a terminal pin or lead of a complementary electrical device.

In the exemplary embodiment of the invention, the substrate or circuit board has a given thickness defining an upper surface and a lower surface. A dielectric housing is adapted for mounting on the upper surface of the substrate and includes a receptacle extending into an appropriate hole in the substrate. A terminal is mounted on the housing and includes a contact portion in registry with the receptacle in the housing. Therefore, the terminal pin of the complementary electrical device can be engaged with the contact portion of the terminal as the pin is inserted into the receptacle of the housing beyond the upper surface of the substrate.

According to one aspect of the invention, the contact portion of the terminal is bifurcated to define a pair of spaced contacts between which the terminal pin is engaged as the terminal pin is inserted into the receptacle in the housing. The terminal includes a fixed portion mounted to the housing and a flexible portion between the fixed portion and the contact portion to provide for floatability of the contact portion to facilitate engagement thereof by the terminal pin. The fixed portion includes a tail projecting from the housing into engagement with the substrate, such as for connection to an appropriate circuit trace on a circuit board.

According to another aspect of the invention, the receptacle of the housing includes dielectric side walls for substantially surrounding the terminal pin when the pin is inserted into the receptacle. The receptacle includes a bottom wall joined to the side walls to substantially close the receptacle. In the preferred embodiment, the receptacle extends through the thickness of the substrate beyond the lower surface thereof.

As disclosed herein, the dielectric housing includes a plurality of the receptacles for receiving a plurality of terminal pins, such as from a single electrical device. A plurality of the terminals are mounted on the housing for engaging the plurality of terminal pins. Each terminal is stamped and formed of conductive sheet metal material.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded perspective view of an electrical connector embodying the concepts of the invention;

FIG. 2 is a top plan view of the housing of the connector mounting a plurality of terminals;

FIG. 3 is an enlarged perspective view of one of the terminals;

FIG. 4 is a top plan view of the connector;

FIG. 5 is a front elevational view of the connector as viewed in FIG. 4;

FIG. 6 is a side elevational view of the connector as viewed in FIG. 4;

FIG. 7 is an enlarged section taken generally along line 7-7 of FIG. 4, with one of the terminal leads of the complementary electrical device inserted into engagement with one of the terminals;

FIG. 8 is an enlarged section taken generally along line 8-8 of FIG. 4, with the terminal for the one terminal pin shown in phantom;

FIG. 9 is an enlarged section taken generally along line 9-9 of FIG. 4; and

FIG. 10 is schematic exploded perspective view of a typical system of the prior art, as described in the “Background”, above.

### DETAILED DESCRIPTION OF THE PREFERRED EMBODIMENT

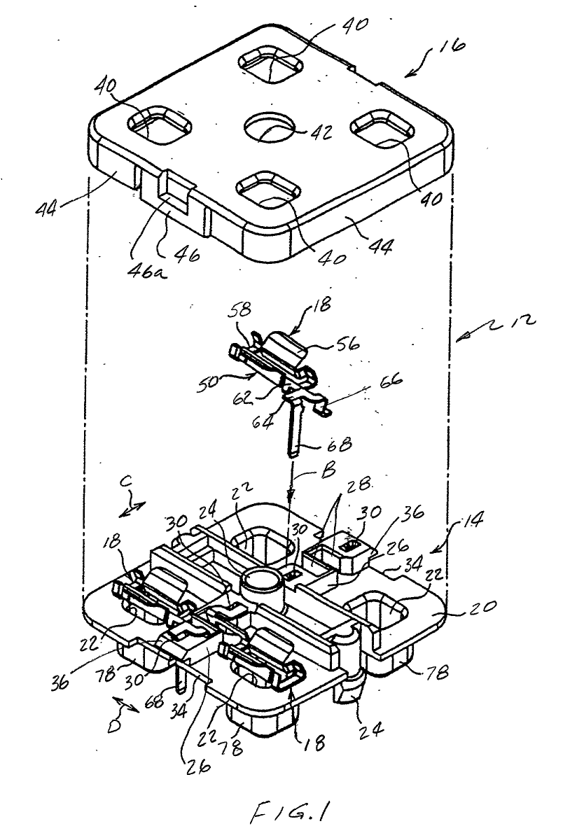

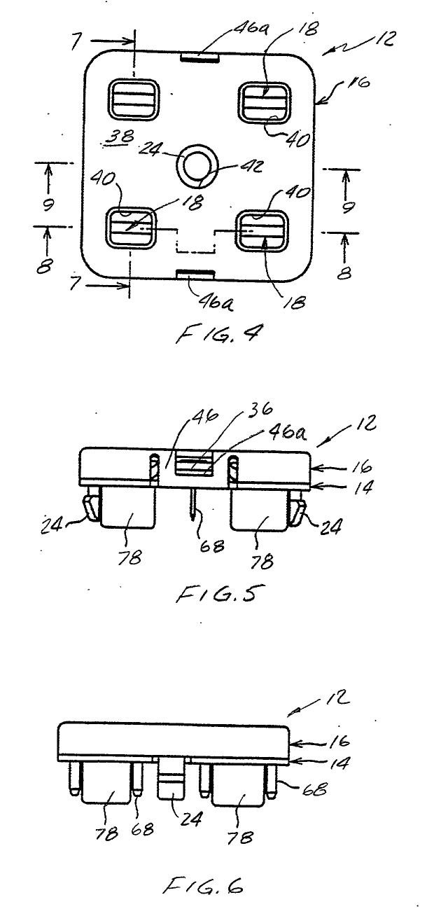

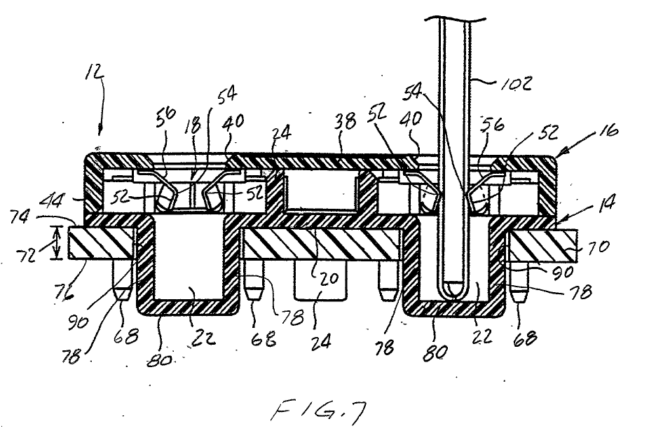

Referring to the drawings in greater detail, and first to FIG. 1, the invention is embodied in an electrical connector or system, generally designated 12, which includes a dielectric housing, generally designated 14, and a cover, generally designated 16. Each of the housing and the cover is a one-piece structure unitarily molded of dielectric material such as plastic or the like. A plurality (four) of terminals, generally designated 18, are mounted on housing 14 and are covered by cover 16. Two of the terminals are shown mounted on the housing in FIG. 1, and one of the terminals is shown elevated above the housing and about to be mounted thereto. FIGS. 4-6 show the connector in assembled condition.

More particularly, housing 14 includes a generally flat base 20 having a plurality of closed receptacles 22 projecting downwardly thereof. A pair of mounting posts 24 also project downwardly from flat base 20. A centering post 24 projects upwardly from the base. A wall structure 26 also projects upwardly from the base. The wall structure defines a pair of slots 28 and a pair of through holes 30, all for purposes described hereinafter. A notch 34 is formed in opposite sides of base 20 in line with an elevated, outwardly projecting chamfered latch 36 at each opposite side of the base.

Cover 16 includes a top plate 38 having four openings 40 which are in registry with receptacles 22 of housing 14 when the cover is positioned onto the housing. An alignment hole 42 in the center of top plate 38 embraces centering post 24 of housing 14. A peripheral wall 44 substantially surrounds top plate 38 of the cover. The cover includes a pair of flexible latch arms 46 at opposite sides thereof. Each latch arm includes a latch hole 46a which snaps over one of the chamfered latches 36 of housing 14 when the cover is mounted on top of the housing to hold the cover on the housing.

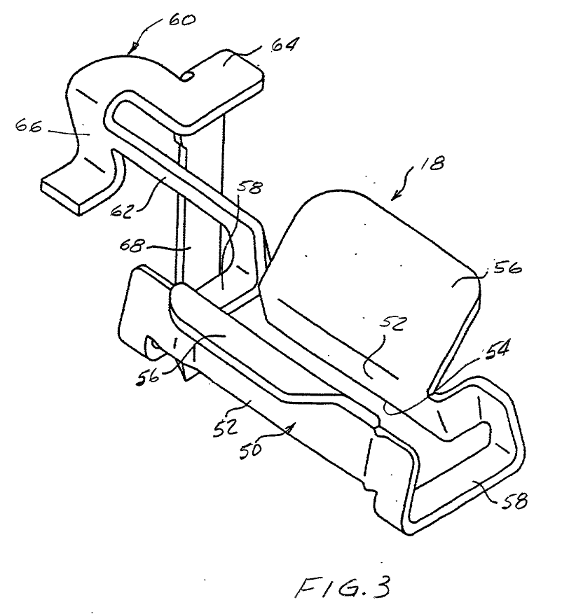

Referring to FIG. 3 in conjunction with FIGS. 1 and 4-6, each terminal 18 includes a contact portion, generally designated 50, which is bifurcated to define a pair of elongated contacts 52. The contacts, in turn, define an elongated slot 54 therebetween. A pair of outwardly flared guide wings project upwardly and outwardly from elongated contacts 52 along opposite sides of slot 54. The contacts are joined at opposite ends of the slot by a pair of generally flat bridge plates 58.

Still referring to FIG. 3, each terminal 18 is stamped and formed of conductive sheet metal material and includes a fixing portion, generally designated 60, joined to contact portion 50 by a flexible portion or arm 62. Therefore, contact portion 50 can flex relative to fixing portion 60. The fixing portion includes a flat plate 64 and a locating arm 66 from which flexible arm 62 extends. A tail 68 extends downwardly from flat plate 64.

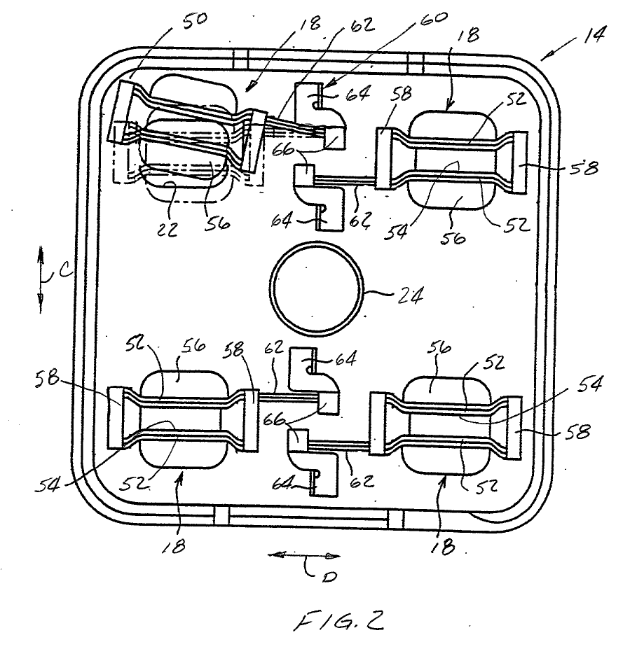

Referring back to FIGS. 1 and 2 in conjunction with FIG. 3, when each terminal 18 is mounted on top of housing 14, tail 60 of the terminal is inserted into an appropriate one of the through holes 30 as indicated by arrow “B” in FIG. 1. The terminal is inserted until locating arm 66 of the terminal seats within the adjacent slot 28 of the housing, and flat plate 64 of the terminal abuts against the top of wall structure 26 of the housing. In essence, flat plate 64, locating arm 66 and tail 64 combine to fix the terminal to the housing. When the terminal is fully inserted or mounted on the housing, contact portion 50 of the terminal is in registry with a respective one of receptacles 22 of the housing, as bridge plates 58 of the terminal rest on top of flat base 20 of the housing. It can be understood that contact portion 50 can flex relative to fixing portion 60 because of flexible arm 62.

Although the complementary electrical device and its terminal pins or leads (i.e., 100 and 102 in FIG. 10) are not shown in FIG. 2, the complementary electrical device can float relative to connector housing 14 (and cover 16) in the direction of double-headed arrows “C” and “D” because of the construction of terminals 18. In particular, terminal 18 shown in the upper left-hand corner of FIG. 2 shows contact portion 50 of that terminal in full lines and in phantom to illustrate the flexing of the contact portion relative to fixing portion 60 of the terminal. This flexing is afforded by flexible arm 62 interconnecting the contact portion and the fixing portion. Since all of the terminals have similar constructions, the entire complementary electrical device can float relative to the housing in the direction of double-headed arrow “C”. In addition, it can be seen in FIG. 2 that all of terminals 18 are oriented so that all of the elongated slots 54 between elongated contacts 52 are generally parallel. Therefore, the terminal pins or leads from the complementary electrical device can move longitudinally within slots 54 and allow for floating movement between the complementary electrical device and connector housing 14 in the direction of double-headed arrow “D”.

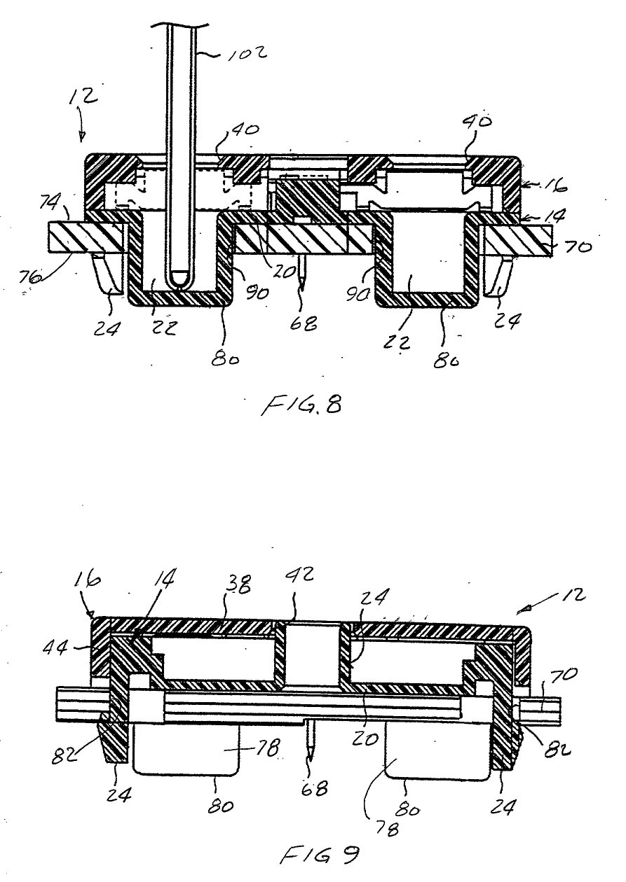

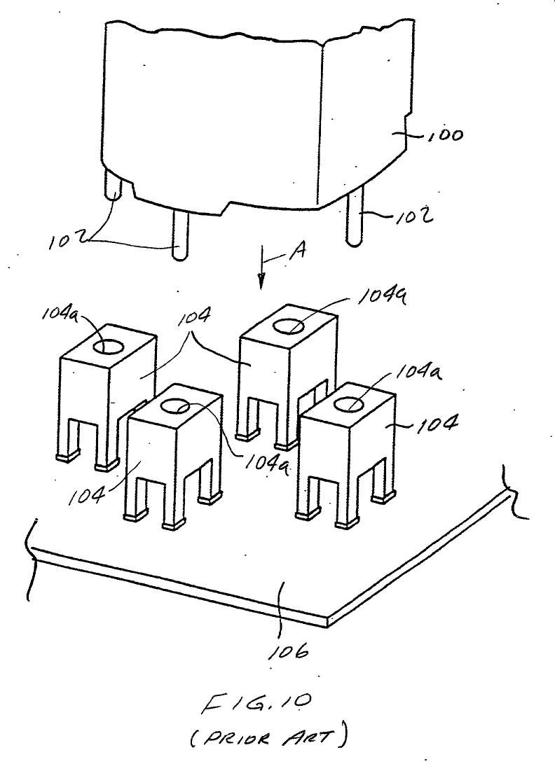

FIGS. 7-9 show electrical connector 12 mounted on a substrate or circuit board 70 which has a given thickness 72 defining an upper surface 74 and a lower surface 76. FIGS. 7 and 8 also show one of the terminal pins or leads 102 inserted into the connector. FIGS. 7 and 8 show that each receptacle 22 is a closed receptacle defined by side walls 78 and a bottom wall 80. This completely protects the terminal pins or leads from possible shorting. Tails 68 of terminals 18 can be seen projecting below the circuit board. The terminals are connected to appropriate circuit traces (not shown) on the circuit board or in appropriate holes in the board for receiving the tails. FIG. 9 best shows mounting posts 24 extending through holes 82 in circuit board 70 for mounting the connector to the board. FIG. 9 also shows centering post 24 of housing 14 projecting upwardly through alignment hole 42 in cover 16.

FIGS. 7 and 8 best show how receptacles 22 project downwardly from flat base 20 through holes 90 in circuit board 70. When connector 12 is mounted on top of the circuit board, flat base 20 of housing 14 rests on upper surface 74 of the circuit board. Receptacles 22 extend through holes 90 completely beyond lower surface 76 of the circuit board. FIG. 7 shows how terminal pin 102 extends past contacts 52 of terminals 18 and into the respective receptacle 22, also beyond lower surface 76 of the circuit board. By allowing the terminal pins to extend completely through the cover and housing of the connector and beyond the circuit board into receptacles 22, the entire height profile of the system is significantly reduced. It can be understood that mounting posts 24 of the connector housing and tails 68 of the terminals already extend through the circuit board, so that terminal pins 102 do not increase the height profile of the system below the circuit board but significantly decrease the height profile of the overall system because complementary electrical device 100 (FIG. 10) can be moved downwardly significantly closer to the circuit board.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

We claim:

1. An electrical connector for mounting on a substrate which has a given thickness defining an upper surface and a lower surface and for receiving a terminal pin of a complementary electrical device, comprising:
a dielectric housing adapted for mounting on the upper surface of the substrate and including a receptacle extending into an appropriate hole in the substrate; and
a terminal mounted on the housing and including a contact portion in registry with the receptacle in the housing,
whereby said terminal pin of the complementary electrical device can be engaged with the contact portion of the terminal as the pin is inserted into the receptacle of the housing beyond the upper surface of the substrate.

2. The electrical connector of claim 1 wherein said contact portion of the terminal is bifurcated to define a pair of spaced contacts between which the terminal pin is engaged as the terminal pin is inserted into the receptacle in the housing.

3. The electrical connector of claim 1 wherein said terminal includes a tail portion projecting from the housing into engagement with the substrate.

4. The electrical connector of claim 1 wherein said terminal includes a fixed portion mounted to the housing and a flexible portion between the fixed portion and said contact portion to provide for floatability of the contact portion and thereby facilitate engagement thereof by the terminal pin.

5. The electrical connector of claim 4 wherein said fixed portion of the terminal includes a tail projecting from the housing into engagement with the substrate.

6. The electrical connector of claim 1 wherein said receptacle of the housing includes dielectric side walls for substantially surrounding the terminal pin when the pin is inserted into the receptacle.

7. The electrical connector of claim 6 wherein said receptacle includes a bottom wall joined to the side walls to substantially close the receptacle.

8. The electrical connector of claim 1 wherein said receptacle extends through the thickness of the substrate beyond the lower surface thereof.

9. The electrical connector of claim 1 wherein said dielectric housing includes a plurality of said receptacles for receiving a plurality of terminal pins, with a plurality of said terminals mounted on the housing for engaging the terminal pins.

10. The electrical connector of claim 1 wherein said terminal is stamped and formed of conductive sheet metal material.

11. An electrical connector for mounting on a substrate which has a given thickness defining an upper surface and a lower surface and for receiving a plurality of terminal pins of a complementary electrical device, comprising:
a dielectric housing adapted for mounting on the upper surface of the substrate and including a plurality of receptacles extending through the thickness of the substrate beyond the lower surface thereof, each receptacle including dielectric side walls for substantially surrounding a respective terminal pin when the pin is inserted into the receptacle; and
a plurality of stamped and formed sheet metal terminals mounted on the housing with contact portions in registry with respective ones of the receptacles in the housing and each terminal including a tail portion projecting from the housing into engagement with the substrate,
wherein said terminal pins of the complementary electrical device can be engaged with the contact portions of the terminals as the pins are inserted into the receptacles of the housing beyond the lower surface of the substrate.

12. The electrical connector of claim 11 wherein said contact portion of each terminal is bifurcated to define a pair of spaced contacts between which a terminal pin is engaged as the terminal pin is inserted into a respective receptacle in the housing.

13. The electrical connector of claim 11 wherein each terminal includes a fixed portion mounted to the housing and a flexible portion between the fixed portion and said contact portion to provide for floatability of the contact portion and thereby facilitate engagement thereof by the terminal pin.

14. The electrical connector of claim 4 wherein said fixed portion of each terminal includes a tail projecting from the housing into engagement with the substrate.

15. The electrical connector of claim 11 wherein each receptacle includes a bottom wall joined to the side walls to substantially close the receptacle.

16. An electrical connector system for receiving a terminal pin of a complementary electrical device, comprising:
a circuit board having a given thickness defining an upper surface and a lower surface;
a dielectric housing adapted for mounting on the upper surface of the circuit board and including a receptacle extending into an appropriate hole in the circuit board; and
a terminal mounted on the housing and including a contact portion in registry with the receptacle in the housing,
whereby said terminal pin of the complementary electrical device can be engaged with the contact portion of the terminal as the pin is inserted into the receptacle of the housing beyond the upper surface of the circuit board.

17. The system of claim 16 wherein said contact portion of the terminal is bifurcated to define a pair of spaced contacts between which the terminal pin is engaged as the terminal pin is inserted into the receptacle in the housing.

18. The system of claim 16 wherein said terminal includes a tail portion projecting from the housing into engagement with the circuit board.

19. The system of claim 16 wherein said terminal includes a fixed portion mounted to the housing and a flexible portion between the fixed portion and said contact portion to provide for floatability of the contact portion and thereby facilitate engagement thereof by the terminal pin.

20. The system of claim 19 wherein said fixed portion of the terminal includes a tail projecting from the housing into engagement with the circuit board.

21. The system of claim 16 wherein said receptacle of the housing includes dielectric side walls for substantially surrounding the terminal pin when the pin is inserted into the receptacle.

22. The system of claim 21 wherein said receptacle includes a bottom wall joined to the side walls to substantially close the receptacle.

23. The system of claim 16 wherein said receptacle extends through the thickness of the circuit board beyond the lower surface thereof.

24. The system of claim 16 wherein said dielectric housing includes a plurality of said receptacles for receiving a plurality of terminal pins, with a plurality of said terminals mounted on the housing for engaging the terminal pins.

25. The system of claim 16 wherein said terminal is stamped and formed of conductive sheet metal material.
